(19) United States
(12) Patent Application Publication
(10) Pub. No.: US 2023/0345982 A1
(43) Pub. Date: Nov. 2, 2023

(54) Seasoning From Malted Rice Used as Raw Material

(71) Applicant: Kikkoman Corporation, Chiba (JP)

(72) Inventors: Yusuke Ito, Chiba (JP); Taichi Koizumi, Chiba (JP); Takeharu Nakahara, Chiba (JP); Izumi Kobayashi, Chiba (JP)

(21) Appl. No.: 18/041,146

(22) PCT Filed: Aug. 18, 2021
(86) PCT No.: PCT/JP2021/030138

§ 371 Date: Feb. 9, 2023

(30) Foreign Application Priority Data
Aug. 19, 2020 (JP) 2020-138425

(51) Int. Cl. A23L 27/10; A23L 27/00

(52) U.S. Cl. CPC A23L 27/10; A23L 27/88

(57) ABSTRACT

The present invention relates to a seasoning from malted rice used as a raw material containing 0.3 ppm or more of maltol and/or 0.25 ppm or more of methional, and 10% (w/v) or more of glucose.

### TECHNICAL FIELD

The present invention relates to a seasoning from malted rice used as a raw material.

### BACKGROUND ART

Since the climate in Japan is hot and humid, and it is easy for microorganisms to grow, various fermented foods and seasonings have been conventionally used. Among them, seasonings from malted rice used as a raw material have umami, richness and refined sweetness derived from rice. In particular, Mirin from malted rice used as a raw material are widely used as seasonings at home since they contain a large number of sugar components as compared with sugar, which contains only sucrose, so that Mirin have a mild sweetness and can impart a deep taste. Further, Mirin are known to have various cooking effects. Up to now, for purpose of developing a product with a different quality of sweetness than conventional products, a product with a high effect of suppressing the smell of meat, or a product with enhanced gloss effect or moisture retention, various studies have been conducted on the composition and the manufacturing method of seasonings from malted rice used as a raw material (e.g., see Patent Literatures 1, 2, and 3).

Meanwhile, although the effect of the aroma components in cooking have been reported, there is little knowledge about them in mirin and they are not investigated enough.

### CITATION LIST

### Patent Literatures

Patent Literature 1: Japanese Patent Laid-Open No. 2017-12126

Patent Literature 2: Japanese Patent Laid-Open No. 2009-22266

Patent Literature 3: Japanese Patent Laid-Open No. 2003-47455

Patent Literature 4: Japanese Patent Laid-Open No. 2018-68293

### SUMMARY OF INVENTION

### Technical Problem

Conventionally, sufficient attempts have not been made to positively enhance the effects of seasonings from malted rice used as a raw material, such as thickness of taste, fragrantness and continuity of taste.

It is an object of the present invention to provide a seasoning from malted rice used as a raw material having excellent thickness of taste, fragrantness and continuity of taste.

### Solution to Problem

Therefore, as a result of diligent studies, the inventors have found that, when a specific amount of maltol or methional is contained, a seasoning from malted rice used as a raw material that enhances the thickness of taste, fragrantness and the continuity of taste of taste can be obtained, thereby achieving the present invention.

More specifically, the present invention is as follows.
[1] A seasoning from malted rice used as a raw material, comprising 0.3 ppm or more of maltol and 10% (w/v) or more of glucose.
[2] A seasoning from malted rice used as a raw material, comprising 0.25 ppm or more of methional and 10% (w/v) or more of glucose.
[3] A seasoning from malted rice used as a raw material, comprising 0.3 ppm or more of maltol, 0.25 ppm or more of methional, and 10% (w/v) or more of glucose.
[3-1] A seasoning from malted rice used as a raw material, having a maltol concentration in the seasoning of 0.3 ppm or more, preferably 0.35 ppm or more, more preferably 0.4 ppm or more, and/or a methional concentration in the seasoning of 0.25 ppm or more, preferably 0.3 ppm or more, more preferably 0.35 ppm or more, and a glucose concentration in the seasoning of 10% (w/v) or more, preferably 15% (w/v) or more, more preferably 20% (w/v) or more.
[4] The seasoning from malted rice used as a raw material according to any one of [1] to [3-1], being Mirin, Amazake, sweetener, salted rice malt, fermented glutinous rice (Jiu Niang), syrup, or glucose syrup, preferably Mirin, sweetener, or Amazake, more preferably Mirin.

### Advantageous Effect of Invention

The present invention can provide a seasoning from malted rice used as a raw material having excellent thickness of taste, fragrantness and continuity of taste.

### BRIEF DESCRIPTION OF DRAWINGS

FIG. 1 shows the effect of enhancing the thickness of taste and the continuity of taste in Example 1.

FIG. 2 shows the effect of enhancing the thickness of taste and the continuity of taste when using a control Mirin having a glucose concentration of 8.5% (w/v).

FIG. 3 shows the effect of enhancing the thickness of taste, the fragrantness, the continuity of taste in Example 2.

### DESCRIPTION OF EMBODIMENT

Hereinafter, the present invention will be described specifically, but the present invention is not limited to the following embodiments and can be carried out with various modifications.

(Seasoning from Malted Rice Used as Raw Material)

Seasonings from malted rice used as a raw material are produced by decomposing grain-derived starches, proteins, or the like with enzymes or chemical reactions, using steamed rice on which microorganisms, mainly molds such as koji mold that is effective in food fermentation have grown as a main raw material. Examples thereof include Mirin, Amazake, sweetener, salted rice malt, fermented glutinous rice (Jiu Niang), syrup and glucose syrup. Among them, the seasoning from malted rice used as a raw material may be in liquid form and is preferably Mirin, Amazake, or sweetener, more preferably Mirin.

The seasoning from malted rice used as a raw material may be produced by appropriately selecting a culture environment such as appropriate temperature, humidity, air, and fermentation raw materials (including additives) so that predetermined microorganisms grow.

The rice used for producing the seasoning from malted rice used as a raw material is not specifically limited, and all types of rice such as non-glutinous rice and glutinous rice may be used.

Rice suitable for each seasoning from malted rice used as a raw material such as Mirin, Amazake, sweetener, salted rice malt, fermented glutinous rice (Jiu Niang), syrup or glucose syrup may be used as malted rice.

Koji mold, which is used in production of malted rice, refers to a group of fungi that produce malt and similar fungi. Koji mold used for each seasoning from malted rice used as a raw material such as Mirin, Amazake, sweetener, salted rice malt, fermented glutinous rice (Jiu Niang), syrup, and glucose syrup may be used, and examples thereof include yellow koji mold, which is a representative strain used for brewing Mirin or the like, white koji mold which is a strain isolated from Okinawa Awamori Black koji mold as an albino mutant, and black koji mold, which is generally widely known in Okinawa as Awamori Aspergillus and is a strain conventionally used for brewing Awamori.

The seasoning from malted rice used as a raw material of the present invention contains maltol and/or methional but may contain additives other than maltol and methional for improving the thickness of taste, the fragrantness and the continuity of taste.

### (Maltol)

The seasoning from malted rice used as a raw material of the present invention may contain maltol for further improving the thickness, the fragrantness and the continuity of taste.

Maltol is a naturally occurring organic compound having a structure represented by formula (1) below, is a substance used as a spice or a food additive, has a sweet caramel-like aroma, and is known to have the effect of suppressing the heating odor of meat and the effect of enhancing the richness.

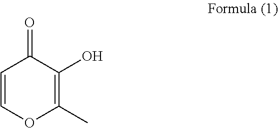

The seasoning from malted rice used as a raw material according to the present invention preferably has a concentration of maltol at which the effect of improving the thickness of taste, the fragrantness and the continuity of taste can be exerted more than when using a conventional seasoning from malted rice used as a raw material.

Specifically, the concentration of maltol is 0.3 ppm or more, preferably 0.35 ppm or more, more preferably 0.4 ppm or more.

### (Methional)

The seasoning from malted rice used as a raw material of the present invention may contain methional for further improving the thickness of taste, the fragrantness and the continuity of taste.

Methional is a natural aroma component having a structure represented by formula (2) below, has a function of regulating the activity of Umami taste receptors, and is involved in the thickness of taste, the fragrantness and the continuity of taste in fermented products.

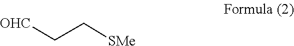

The seasoning from malted rice used as a raw material of the present invention preferably has a concentration of methional at which the effect of improving the thickness of taste, the fragrantness and the continuity of taste can be exerted more than when using a conventional seasoning from malted rice used as a raw material.

Specifically, the concentration of methional is 0.25 ppm or more, preferably 0.3 ppm or more, more preferably 0.35 ppm or more.

The seasoning from malted rice used as a raw material of the present invention preferably contains maltol and methional for further improving the thickness of taste, the fragrantness and the continuity of taste.

Containing both maltol and methional allows the thickness of taste, the fragrantness and the continuity of taste to be improved further than when containing each in a specific amount.

When containing both maltol and methional, the concentration of maltol is preferably 0.3 ppm or more, and the concentration of methional is preferably 0.25 ppm or more.

The concentration of maltol is preferably 0.3 ppm or more, more preferably 0.35 ppm or more, further preferably 0.4 ppm or more, when the concentration of methional is 0.25 ppm or more or in a preferable concentration range.

The concentration of methional is 0.25 ppm or more, preferably 0.3 ppm or more, more preferably 0.35 ppm or more, when the concentration of maltol is 0.3 ppm or more or in a preferable concentration range.

For further improving the thickness of taste, the fragrantness and the continuity of taste, the aforementioned concentrations of maltol and methional may be contained, and the concentration ratio of maltol to methional may be appropriately set.

Maltol or methional may be present in a conventional seasoning from malted rice used as a raw material at a certain concentration, 8.34 (±0.92) μg/L of maltol and 16.3 (±0.6) μg/L of methional are contained in a general Hon Mirin (see Biosci Biotechnol Biochem. 2015; 79 (3): 484-7).

The seasoning from malted rice used as a raw material of the present invention is superior in the thickness of taste, the fragrantness and the continuity of taste to a conventional seasoning from malted rice used as a raw material by containing maltol or methional at a specific concentration or more.

### (Glucose)

The seasoning from malted rice used as a raw material of the present invention contains glucose.

The concentration of glucose is 10% (w/v) or more, preferably 15% (w/v) or more, more preferably 20% (w/v) or more, with respect to the total volume of the seasoning from malted rice used as a raw material.

Glucose may be produced by using cereal-derived starch enzymes or chemical reactions or may be added. Further, glucose derived from both may be contained.

The seasoning from malted rice used as a raw material of the present invention may contain saccharides other than glucose. Examples of the saccharides other than glucose include nigerose, maltose, isomaltose, trehalose, kojibiose, isomaltotriose, panose, and maltotetraose.

The seasoning from malted rice used as a raw material of the present invention may contain amino acids, vitamins, minerals, organic acids, alcohols, carbonyl compounds and aldehydes.

Further, the seasoning from malted rice used as a raw material of the present invention may contain aroma components and may contain dietary fibers and components having the effect of improving the physical conditions.

### (Mirin)

Examples of the Mirin include Hon Mirin, Mirin-like seasonings, and fermented seasonings.

Hon Mirin includes products obtained by adding rice, malted rice, brewed alcohol, or Shochu, and other raw materials specified by the Liquor Tax Act and saccharifying and maturing it. Those classified as Mirin by the Liquor Tax Act are Hon Mirin. Then, Jun-mai Hon Mirin is Hon Mirin in which all of the sugar contents are derived from rice or malted rice.

The seasoning from malted rice used as a raw material of the present invention is preferably Hon Mirin but may be Mirin that is classified as a Mirin-like seasoning or a fermented seasoning.

Hon Mirin is generally produced by the following method.

Using polished glutinous rice and the crushed glutinous rice as raw materials, the rice is washed, soaked and steamed. For saccharification and maturation, it is used together with koji mold, Shochu, or alcohol, and saccharifying enzymes added, as required, in the mush (moromi) preparation process. The mush (moromi) after maturation is filtered to remove the residue, followed by a heating process, as required.

Mirin-like seasonings have a taste made to resemble Hon Mirin by adding sugar contents such as glucose syrup and Umami seasoning.

Fermented seasonings are treated to be inedible by adding salt for fermentation and maturation and produced by adding auxiliary raw materials such as saccharine materials, malts, and denatured alcohols.

### (Amazake)

Examples of the Amazake include sweet beverages made by saccharifying starch using rice and malted rice as raw materials.

To give an example of the manufacturing method of Amazake, when using malted rice and rice as raw materials, the rice gruel made with water is kept at a temperature of about 50 to 60 degrees, malted rice is mixed and stirred, and starch is saccharified overnight (about 10 to 12 hours) with an enzyme (amylase) derived from koji mold to obtain sweetness. In the saccharification process, decomposition of proteins into amino acids by proteases and lactic acid fermentation by contamination of lactic acid bacteria may also proceed, in addition to the saccharification by amylase of koji mold.

The product obtained by uniformly dissolving sake lees in hot water and sweetened with sugar is also called Amazake, but such Amazake may also be Amazake as the seasoning from malted rice used as a raw material of the present invention.

### (Sweetener, Salted Rice Malt, Fermented Glutinous Rice (Jiu Niang), Syrup, and Glucose Syrup)

The sweetener, salted rice malt, fermented glutinous rice (Jiu Niang), syrup, and glucose syrup are not specifically limited, as long as they are seasonings corresponding to sweetener, salted rice malt, fermented glutinous rice (Jiu Niang), syrup, and glucose syrup, respectively.

The sweetener, salted rice malt, fermented glutinous rice (Jiu Niang), syrup, and glucose syrup can be produced by conventionally known methods.

Examples of the method for producing the seasoning from malted rice used as a raw material of the present invention include (1) a method of increasing maltol and/or methional in the saccharification/maturation process or the brewing/fermentation process, and (2) a method of separately adding them. Further, the methods (1) and (2) may be combined.

Maltol may have a predetermined concentration in the method (1) and/or (2), methional may have a predetermined concentration in the method (1) and/or (2), or maltol may have a predetermined concentration in the method (1) and/or (2), and methional may have a predetermined concentration in the method (1) and/or (2) in any combination.

Examples of the method of increasing maltol and/or methional in the saccharification/maturation process or the brewing/fermentation process include a method of adjusting various conditions and raw materials in the saccharification/maturation process or the brewing/fermentation process so that the final concentrations fall within the range of the present invention.

Examples thereof include a method of generating them by the chemical reactions during brewing and a method of generating them due to the fermentation of microorganisms.

The method of increasing maltol and/or methional may refer to methods of increasing maltol or methional in the saccharification/maturation process or the brewing/fermentation process in the method for products other than seasonings using malted rice as a raw material.

As a method of separately adding maltol and/or methional, maltol and/or methional may be contained in a seasoning from malted rice used as a raw material to be obtained by adding maltol and/or methional to the seasoning from malted rice used as a raw material produced by a conventional method or in any step for producing a seasoning from malted rice used as a raw material in a conventional method.

The form of the maltol and methional to be added is not limited, but examples thereof include chemically synthesized materials and food additives extracted, isolated, or purified from plants.

Maltol and methional may be simultaneously or sequentially added, or may be added in different steps.

Further, a generation method by adding components necessary for Shochu containing a high amount of maltol or the Maillard reaction may be employed.

### EXAMPLES

Hereinafter, the present invention will be described further in detail by way of examples, but the present invention is not limited to these examples.

### Example 1 (Cooking Effect with Broth)

1) The Mirin obtained by adding maltol to commercially available “Hinode Hon Mirin (Junryou)”, available from KING BREWING CO., LTD. (which will be hereinafter referred to as “the control Mirin”) to a final concentration of 0.3 ppm, 2) the Mirin obtained by adding methional to the control Mirin to a final concentration of 0.25 ppm, and 3) the Mirin obtained by adding maltol to the control Mirin to a final concentration of 0.3 ppm and adding methional to the control Mirin to a final concentration of 0.25 ppm were prepared. The control Mirin contained 0.007 (±0.001) ppm of maltol and 0.0022 (±0.0027) ppm of methional.

Further, a liquid seasoning used for sensory evaluation was prepared so that sodium chloride was 16%, sodium glutamate was 1.3%, alcohol was 3%, and the pH was 4.9 (prepared with lactic acid).

Using each of the control Mirin and Mirin 1) to 3) above, and the aforementioned liquid seasoning, a broth was prepared, and a sensory evaluation test was performed on the thickness and continuity.

The broth was prepared by mixing 30 mL of each Mirin, 2.5 mL of the liquid seasoning, 0.75 g of salt, 100 mL of water and boiling the mixture over medium flame for 5 minutes using a preheated pan.

The sensory evaluation was conducted by 7 panelists who have the ability to discriminate between the broth using the control Mirin and the broth using Mirin 1) to 3) above on a 7-point scale (3: very strong, 2: strong, 1: slightly strong, 0: the same, −1: slightly weak, −2: weak, −3: very weak), and the average was calculated.

In this example, the definition of each index for the sensory evaluation was as follows.
Thickness of taste: Strength of flavor imparted by taste or aroma
Continuity of taste: Long-lasting taste imparted by taste or aroma in the oral cavity

As a result, as shown in FIG. 1, the thickness and the continuity of taste increased in those to which 0.3 ppm of maltol or 0.25 ppm of methional was added alone, as compared with the control Mirin. Further, the thickness and the continuity of taste remarkably increased in those to which both 0.3 ppm of maltol and 0.25 ppm of methional were added, as compared with those to which each was added alone.

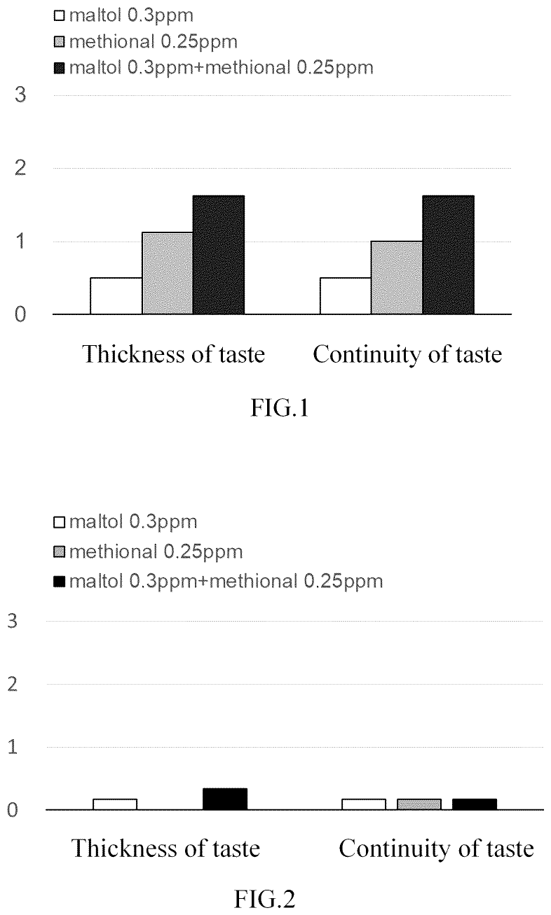

The seasoning of the present invention can improve the thickness of taste, the fragrantness and the continuity of taste by containing 10% (w/v) or more of glucose. For example, when the glucose concentration of the control Mirin was diluted to 8.5% (w/v), the effect on the depth and durability of taste could not be sufficiently obtained in the same sensory evaluation even in the case maltol and methional were added, as shown in FIG. 2.

Further, the control Mirin to which maltol was added to a final concentration in the Mirin of 30 ppm, and methional was added to a final concentration of 25 ppm was produced, and the same sensory evaluation was performed. As a result, the thickness and the continuity of taste increased, as compared with the control Mirin, in the same manner as in the sample with a final concentration of maltol of 0.3 ppm and a final concentration of methional of 0.25 ppm.

### Example 2 (Cooking Effect with Sauce)

1) The Mirin obtained by adding maltol to the control Mirin to a final concentration of 0.36 ppm, 2) the Mirin obtained by adding methional to the control Mirin to a final concentration of 2 ppm, and 3) the Mirin obtained by adding maltol to the control Mirin to a final concentration of 0.36 ppm, and adding methional to the control Mirin to a final concentration of 2 ppm were produced.

Using each of the control Mirin and Mirins 1) to 3) above and commercially available “Koikuchi (dark) soy sauce (Honjouzou)”, available from KIKKOMAN CORPORATION, a sauce was prepared, and a sensory evaluation test was performed on the thickness of taste, the fragrantness and the continuity of taste.

The sauce was prepared by mixing 100 mL of each Mirin and 50 mL of the soy sauce and boiling the mixture over medium flame for 5 minutes using a preheated pan.

The sensory evaluation was conducted by 5 panelists who have the ability to discriminate between the source using the control Mirin and the source using Mirins 1) to 3) above on a 7-point scale (3: very strong, 2: strong, 1: slightly strong, 0: the same, −1: slightly weak, −2: weak, −3: very weak), and the average was calculated.

In this example, the definition of each index for the sensory evaluation was as follows.
Thickness of taste: Strength of flavor imparted by taste or aroma
Continuity of taste: Long-lasting taste imparted by taste or aroma in the oral cavity
Fragrantness: Strong fragrant aroma with burnt feeling (like burnt soy sauce)

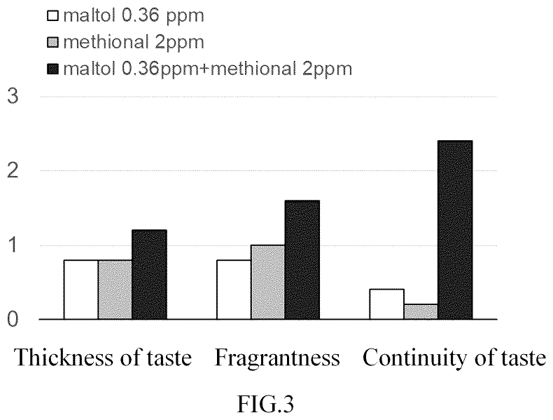

As a result, as shown in FIG. 3, the depth and fragrantness of taste increased in those to which 0.36 ppm of maltol or 2 ppm of methional was added alone. Further, the thickness of taste, the fragrantness and the continuity of taste remarkably increased in those to which both 0.36 ppm of maltol and 2 ppm of methional were added.

1. A seasoning from malted rice used as a raw material, comprising
0.3 ppm or more of maltol and 10% (w/v) or more of glucose.

2. A seasoning from malted rice used as a raw material, comprising
0.25 ppm or more of methional and 10% (w/v) or more of glucose.

3. A seasoning from malted rice used as a raw material, comprising
0.3 ppm or more of maltol, 0.25 ppm or more of methional, and 10% (w/v) or more of glucose.

4. The seasoning from malted rice used as a raw material according to claim 1, being Mirin.

5. The seasoning from malted rice used as a raw material according to claim 2, being Mirin.

6. The seasoning from malted rice used as a raw material according to claim 3, being Mirin.
